(19) United States
(12) Patent Application Publication
(10) Pub. No.: US 2021/0285978 A1
(43) Pub. Date: Sep. 16, 2021

(54) SYSTEMS, METHODS AND DEVICES FOR AUTOMATED DIGESTION OF SAMPLES

(71) Applicant: SEIGNIORY CHEMICAL PRODUCTS LTD., Baie-D'Urfe (CA)

(72) Inventors: George FEILDERS, Beaconsfield (CA); Guobin MA, Dorval (CA); Marco Antonio VILLARREAL, Saint-Lazare (CA); Eugen BRUMAR, Carleton Place (CA); Jeremy James TSIANG, St-Laurent (CA)

(21) Appl. No.: 17/121,845

(22) Filed: Dec. 15, 2020

Related U.S. Application Data
(60) Provisional application No. 62/988,976, filed on Mar. 13, 2020.

(51) Int. Cl. G01N 35/00; G01N 35/02

(52) U.S. Cl. CPC G01N 35/00732; G01N 2035/0465; G01N 2035/00405; G01N 35/026

(57) ABSTRACT

There are described methods, systems, and devices for automated digestion of samples contained in multi-sample racks. The method comprises receiving the multi-sample racks on at least one of a first level and a second level of a first rack loader, the first level and the second level superposed and held within a frame; managing rack positions on the first rack loader by displacing the multi-sample racks between the first level and the second level with at least one elevator; conveying the multi-sample racks into and out of a heating chamber of a microwave digestion system from at least one of the first and second levels; and controlling sample digestion inside the heating chamber through the application of microwaves by at least one microwave generator.

### CROSS-REFERENCE TO RELATED APPLICATIONS

The present application claims the benefit of U.S. Provisional Patent Application No. 62/988,976 filed on Mar. 13, 2020, the contents of which are hereby incorporated by reference in their entirety.

### TECHNICAL FIELD

The present disclosure relates generally to microwave digestion systems, and more particularly to automation of microwave digestion systems.

### BACKGROUND OF THE ART

Microwave digestion systems are used in laboratories to perform thermal decomposition of samples. The samples are provided in closed vessels and the pressure and temperature inside the vessels are raised by exposing the samples to microwave radiation.

Multi-vessel digestion systems can receive large quantities of vessels at a time. When combined with a conveyor system to carry racks of vessels into and out of the microwave cavity, the footprint of the system becomes exceedingly large and requires large laboratory space, which may not be optimal in a laboratory environment. Furthermore, loading, unloading, and general monitoring of sample digestion is a tedious task that requires human resources.

Therefore, improvements are needed.

### SUMMARY

In accordance with a broad aspect, there is provided a method for automated digestion of samples contained in multi-sample racks. The method comprises receiving the multi-sample racks on at least one of a first level and a second level of a first rack loader, the first level and the second level superposed and held within a frame; managing rack positions on the first rack loader by displacing the multi-sample racks between the first level and the second level with at least one elevator; conveying the multi-sample racks into and out of a heating chamber of a microwave digestion system from at least one of the first and second levels; and controlling sample digestion inside the heating chamber through the application of microwaves by at least one microwave generator.

In accordance with another broad aspect, there is provided an automated system for digestion of samples contained in multi-sample racks. The system comprises a microwave digestion system having a heating chamber with an opening and at least one microwave generator communicatively coupled to the heating chamber for propagating therein microwaves to perform digestion of the samples; a first rack loader coupled to the microwave digestion system and aligned with the opening of the heating chamber, the first rack loader having first and second levels superposed inside a first frame, a first set of conveyors for displacing the multi-sample racks between the first rack loader and the heating chamber, and a first elevator displaceable between the first and second levels; and a controller coupled to the microwave generator and the first rack loader and configured to manage displacement of the multi-sample racks on the first rack loader and between the first rack loader and the heating chamber, and control sample digestion through the application of microwaves by the at least one microwave generator.

In accordance with yet another broad aspect, there is provided a rack loader for loading and unloading a plurality of multi-sample racks into and out of a microwave digestion system. The rack loader comprises a frame having a front side, a rear side, and first and second lateral sides spacing apart the front and rear sides; first and second levels superposed inside the frame; a set of conveyors for displacing the multi-sample racks on the rack loader and between the rack loader and a heating chamber of the microwave digestion system; and an elevator displaceable between the first and second levels.

Features of the systems, devices, and methods described herein may be used in various combinations, in accordance with the embodiments described herein.

### BRIEF DESCRIPTION OF THE DRAWINGS

Reference is now made to the accompanying figures in which:

FIG. 1 is a side cross-sectional view of an example automated system for sample digestion;

FIG. 2 is a top cross-sectional view of an example heating chamber of a microwave digestion system;

FIG. 3 is an oblique view of an example rack loader;

FIG. 4 is a side cross-sectional view of an example automated system with multiple rack loaders;

FIG. 5 is an oblique view of the example rack loader of FIG. 3 loaded with seven racks of vessels;

FIG. 6 is a side view of an example conveyor of the rack loader of FIG. 3;

FIG. 7 is a top elevation view of an example first level of the rack loader of FIG. 3;

FIG. 8 is a top elevation view of an example second level of the rack loader of FIG. 3;

FIG. 9 is a back view of another example rack loader;

FIG. 10 is an oblique view of an example first level of the rack loader of FIG. 9, showing a first conveyor being in a rack engaging position; and

FIG. 11 is an oblique view of an example first level of the rack loader of FIG. 9, showing a third conveyor being in a rack engaging position.

It will be noted that throughout the appended drawings, like features are identified by like reference numerals.

### DETAILED DESCRIPTION

There are described herein systems, methods, and devices for automated microwave digestion. At least one rack loader is coupled to a microwave digestion system to form an automated system for digestion of samples contained in multi-sample racks. The rack loader can move the multi-sample racks into and out of the microwave digestion system, for microwave digestion thereof, and can store the racks post-digestion for cooling. The microwave digestion system can digest all samples loaded on the rack loader on a rack per rack basis, if the user does not have a preference of the rack order. The rack loader can also selectively transfer racks into the microwave digestion system in accordance with a priority order. The digestion may be performed in accordance with pre-programmed digestion methods per vessel, per rack, and/or per cycle. When used together, the microwave digestion system and rack loader can provide unattended multiple rack digestions.

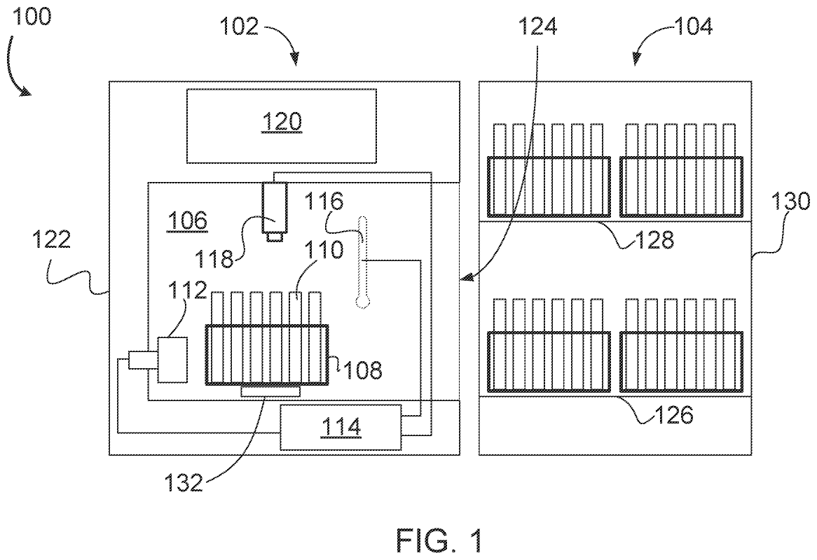

With reference to FIG. 1, there is shown an example embodiment of an automated system 100, comprising a microwave digestion system 102 and a rack loader 104. The microwave digestion system 100 is generally composed of a heating chamber 106 with an opening 124 and at least one microwave device 112 communicatively coupled to the heating chamber 106 for propagating therein microwaves to perform digestion of samples. The samples are contained in sample recipients 110 held in a multi-sample rack 108. The microwave digestion system 102 comprises an outer structure or housing 122 that defines the heating chamber 106. The microwave device 112, at least one imaging device 118, and at least one temperature sensor 116 may be provided in whole or in part inside the heating chamber 106. As used herein, the expression “imaging device” is used to refer to any type of image sensor that detects and conveys information used to make an image. In some embodiments, the image is generated locally to the microwave digestion system 102. In some embodiments, the image is generated remotely to the microwave digestion system 102. The imaging device 118 may be analog or digital, electronic or optical. In some embodiments, the imaging device 118 is a digital camera, an infrared camera, a thermal camera, a charge-coupled device, or an active pixel sensor (i.e. CMOS sensor). An optical fiber or other cable may also be used as part or all of the imaging device 118.

The automated system 100 comprises a controller 114, which can be used to control output of the microwave device 112 and/or image acquisition by the imaging device 118 and receive input from the temperature sensor 116. The controller 114 can be any suitable computer or computing device, as appropriate, for example a microprocessor embedded inside the microwave digestion system 102. In some embodiments, the controller 114 is provided externally to the outer structure 122 of the microwave digestion device 102, for example as a desktop or laptop computer, a mobile computing device, a server or mainframe, and the like, and coupled to the microwave digestion system 112. Coupling of the controller 114 to the microwave digestion system 102 can be performed using any suitable wired or wireless communication techniques.

The sample recipients 110 can take on any suitable size and shape, and can be formed of any suitable material. For example, the sample recipients 112 may be formed of quartz, Teflon™, or any other material which is partially or substantially transparent to light in the visible to infrared spectrum. The microwave digestion system 102 is configured for concurrently accommodating a plurality of sample recipients 110 held by a multi-sample rack 108. In some embodiments, sample recipients 110 of different materials are provided on a same multi-sample rack 108.

In operation, the microwave digestion system 102 subjects the samples in the sample recipients 110 to microwave radiation from the microwave device 112, in accordance with a given digestion method which may be entered or programmed via a user interface 120. In some embodiments, the microwave digestion system 102 has an identification reader 132 inside the heating chamber 106 which is adapted to read an identifier positioned on an exterior surface of the rack 108. In some embodiments, the identifier is positioned on an underside of the rack 108, and the identification reader 132 has a field of view encompassing the underside of the rack 108 as it moves into the heating chamber 106 or when positioned inside the heating chamber 106 at a digestion position. In some embodiments, the identifier is a radio frequency (RF) tag. In these embodiments, the identification reader 132 can be provided in the form of an RF tag reader connected to the controller 114 to automatically get the identifier from each rack 108 of vessels 110. In some embodiments, the controller 114 is adapted to receive the identifier from the identification reader 132 and then apply a set of parameters corresponding to the given rack 108 for digesting the samples of the given rack 108.

The heating chamber 106 is designed to minimize or reduce the degree to which microwave radiation can leak or otherwise escape therefrom, for example using a door or other barrier to seal the opening 124 during digestion of the samples. The microwave device 112 can be any suitable type of microwave device, for example, a waveguide, an antenna, or the like, and can be communicatively coupled to the heating chamber 106 for providing microwave radiation thereto. The microwave radiation produced by the microwave device 112 can be of any suitable intensity, frequency or wavelength, and can be produced substantially continuously, in accordance with a predetermined pattern, or in any suitable fashion. The microwave device 112 can be disposed at any suitable location within the outer structure 122, or can be partially positioned outside the outer structure 122: for instance, a source of microwaves can be positioned adjacent to the outer structure 122, and a waveguide or other similar structure can be used to direct the microwaves to the heating chamber 106.

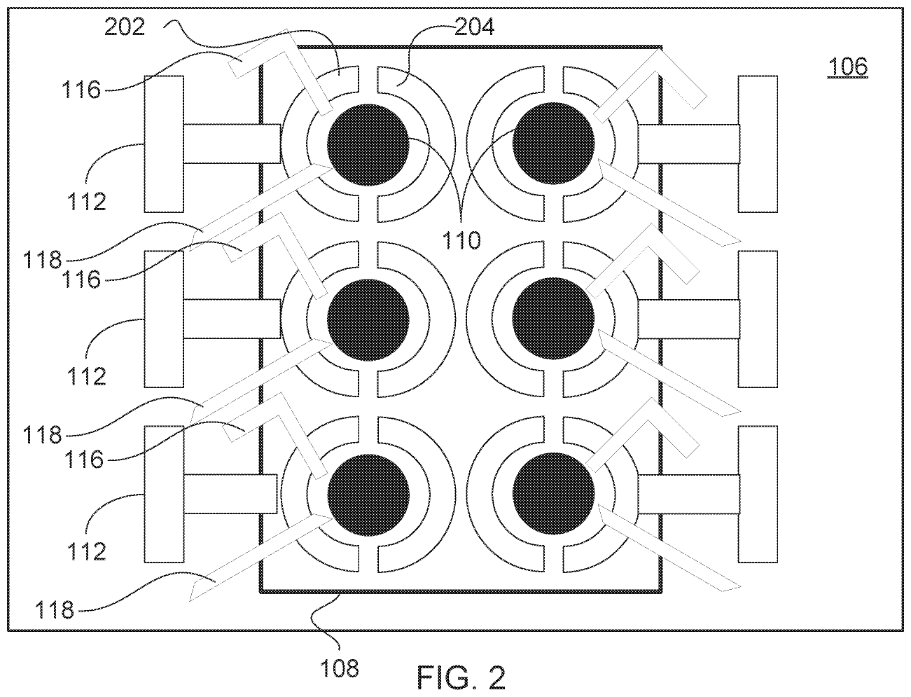

In some embodiments, microwaves are applied to each sample recipient 110 independently. An example embodiment for independent digestion is illustrated in FIG. 2, which shows a cross-sectional top view of the heating chamber 106. Six sample recipients 110 are held by a multi-sample rack 108, but there may be more or less than six. In some embodiments, the multi-sample rack 108 holds twelve sample recipients 110. Each sample recipient 110 has a dedicated microwave device 112 which comprises an applicator 202 that mates with a complimentary structure 204 to form a heating cavity around a given sample recipient 110. The complimentary structure 204 may form part of the multi-sample rack 108 or be otherwise disposed inside the heating chamber 106. Each heating cavity may also comprise an image acquisition device 118 and a temperature sensor 116, to allow independent monitoring of sample digestion for each sample recipient 110.

Referring back to FIG. 1, the rack loader 104 is aligned with the opening 124 for loading and unloading the multi-sample racks 108 into and out of the heating chamber 106 of the microwave digestion system 102. The rack loader 104 comprises a frame 130 having first and second levels 126, 128 superposed. A plurality of multi-sample racks 108 are held on the rack loader 104 and displaced thereon using a set of conveyors and at least one elevator. The conveyors displace the racks 108 front to back and/or side to side on a given level 126, 128, the elevator displaces the racks 108 between levels 126, 128.

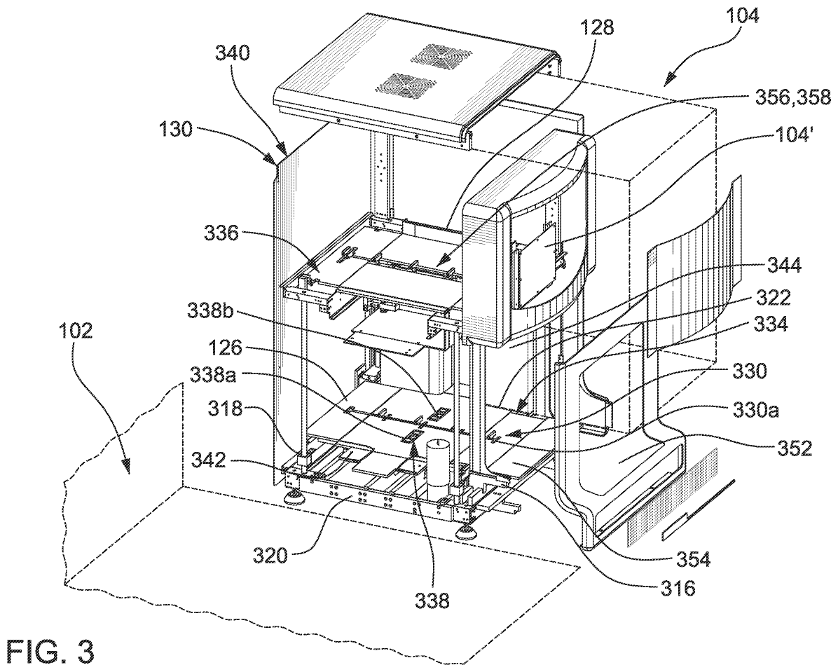

FIG. 3 shows an example embodiment for the rack loader 104. As shown, the rack loader 104 has a frame 130 with a front side 316, a rear side 318, and first and second lateral sides 320 and 322 which space apart the front and rear sides 316 and 318. First and second levels 126 and 128 are superposed inside the frame 130 so as to increase the number of racks 108 of sample recipients 110 which can be stored per unit of laboratory area.

To move the racks inside the rack loader 104, the rack loader 104 has a first conveyor 330 on the first level 126 moving between the front and rear sides 316 and 318 of the frame 130, a second conveyor 332 on the second level 128 moving between the front and rear sides 316 and 318 of the frame 130, and a first elevator 334 displaceable between the first and second levels 126 and 128.

In this specific embodiment, the rack loader 104 has a second elevator 336 which is spaced-apart from the first elevator 334, and which is displaceable between the first and second levels 126 and 128. As depicted, the first elevator 334 is proximate to the front side 316 of the frame 130 and the second elevator 336 is proximate to the rear side 318 of the frame 130. However, it is noted that the second elevator 336 is optional, as it can be omitted in other embodiments, an example of which is described below.

Still referring to FIG. 3, the rack loader 104 has a third conveyor 338 on the first level 126 moving between the first and second lateral sides 320 and 322 of the frame 130. More specifically, in this example, the third conveyor 338 has a first end 338a proximate to the first lateral side 320 of the frame 130 and a second end 338b proximate to the second lateral side 322 of the frame 130.

Accordingly, when the first lateral side 320 of the rack loader 104 is adjoined to the microwave digestion system 102, such as illustrated in this example, racks 108 can be loaded into and unloaded from the microwave digestion system 102 using the third conveyor 338.

It is intended that the first and second conveyors 330 and 332 and the first and second elevators 334 and 336 can be used to queue up undigested one(s) of the racks 108 towards the microwave digestion system 102 for microwave digestion thereof and then to store digested one(s) of the racks 108 after said microwave digestion.

As shown in this example, the frame 130 is provided in the form of a housing 340 enclosing the first and second levels 126 and 128, the first, second and third conveyors 330, 332 and 338 and the first and second elevators 334 and 336.

The housing 340 can have one or more openings leading to either one or both of the first and second levels 126 and 128. More specifically, in this specific example, the housing 340 has a first opening 342 on the first lateral side 320 of the frame 130 adjacent to the first end 338A of the third conveyor 338, and a second opening 344 on the second lateral side 322 of the frame 130 adjacent to the second end 338B of the third conveyor 338. Accordingly, a given rack 108 can be moved from the third conveyor 338 to the microwave digestion system 102 via the first opening 342.

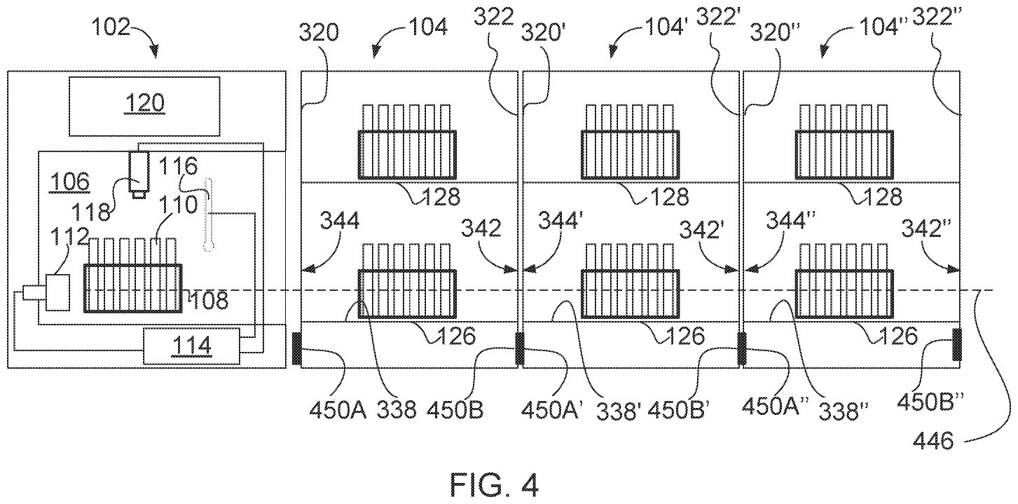

In an embodiment, a given rack 108 can also be received from an adjacent rack loader 104′ to the third conveyor 338 via the second opening 342, as best shown in FIG. 4. As shown in this example, rack loaders 104, 104′ and 104″ are aligned in series relative to one another such that their respective third conveyors 338, 338′ and 338″ are aligned along a common lateral orientation 446. A given rack 108 can be moved from the farthest one of the rack loaders 104, 104′ and 104″ to a closest one of the rack loaders 104, 104′ and 104″ through respective first and second openings 342, 342′, 342″ and 344, 344′, 344″ using the third conveyors 338, 338′ and 338″. It was found that aligning a plurality of such rack loaders 104, 104′ and 104″ can increase the number of queued undigested racks 108 and/or stored digested racks 108 per units of laboratory area.

In some embodiments, first and second lateral sides 320, 320′, 320″ and 322, 322′, 322″ of rack loaders 104, 104′ and 104″ have corresponding alignment features 450A, 450A′, 450A″ and 450B, 450B′, 450B″. Accordingly, when the alignment feature 450B of the second lateral side 322 of the rack loader 104 is aligned to the alignment feature 450A′ of the first lateral side 320′ of the adjacent rack loader 104′, the third conveyors 338 and 338′ of the rack loaders 104 and 104′ are aligned with one another along the common lateral orientation 446 leading to the microwave digestion system 102.

In some embodiments, the alignment feature 450B of the second lateral side 322 of the rack loader 104 comprises a female mating element and the alignment feature 450A′ of the first lateral side 320′ of the rack loader 104′ comprises a male mating element. Accordingly, the female mating element of the second lateral side 322 of the rack loader 104 can be matingly engaged to the male mating element of the first lateral side 320 of the adjacent rack loader 104′, to avoid misalignments between the two adjacent rack loaders 104 and 104′.

Referring back to FIG. 3, the housing 340 has a third opening 352 in this example. More specifically, the third opening 352 is adjacent a first end 330A of the first conveyor 330. In this embodiment, the rack loader 104 has a rack receiving deck 354 which is coplanar with the first level 126 and disposed at the front side 316 of the frame 130. As shown, the rack receiving deck 354 is accessible via the third opening 352 of the housing 340. However, the rack receiving deck 354 may also be at the rear side 318 in some other embodiments.

In some embodiments, the rack loader 104 has a controller 356 which is communicatively coupled to the first, second and third conveyors 30, 32 and 38 and to the first and second elevators 34 and 36 in this example. The controller 356 is provided in the form of a printed-circuit board in this example. The controller 356 can be remote from the rack loader 104 in alternate embodiments. The controller 356 also communicates with the controller 114 of the microwave digestion system 102 to get a command to send a rack 108 to the microwave digestion system 102 for digestion thereof. Similarly, the controller 356 can communicate with the controller 114 of the microwave digestion system 102 to take a rack out of the microwave digestion system 102 after a digestion is finished. The controller 356 can also update the controller 114 of the microwave digestion system 102 with the racks loaded on rack loaders 104, 104′ and 104″, as well as which racks are digested and which racks are queued. Status information can be displayed on a display of the user interface 120 of the microwave digestion system 102.

A power source can be provided inside the frame 130 for powering, for instance, the first, second and third conveyors 330, 332 and 338, the first and second elevators 334 and 336 and the controller 356. The power source can be provided in the form of a removable battery pack in some embodiments whereas the power source can be connectable to a wall power outlet in some other embodiments.

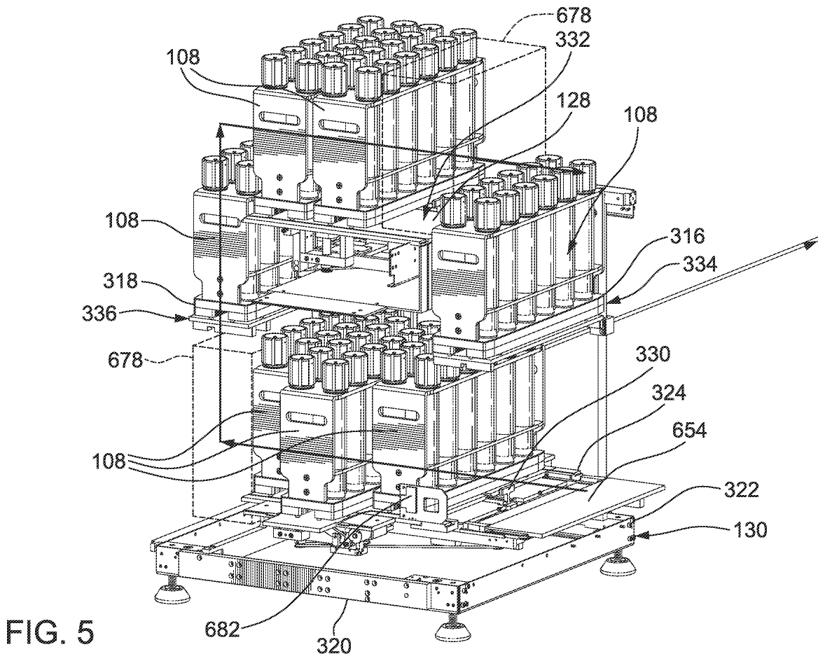

FIG. 5 shows the rack loader 104 being loaded with seven racks 108 of vessels, the housing 340 being omitted. As shown in this example, a given rack 108 of vessels received on the rack receiving deck 354 of the first level 126 can be moved from the front side 316 to the rear side 318 using the first conveyor 330, then from the first level 126 to the second level 128 using the second elevator 336, then from the rear side 318 to the front side 316 using the second conveyor 332, and from the second level 128 back to the rack receiving deck 354 of the first level 126 using the first elevator 334. An opposite or otherwise different path could also be taken. Accordingly, any given rack 108 can be moved as desired across the rack loader 104.

In some embodiments, the rack receiving deck 354 may not overlap with the first conveyor 330. In such embodiments, racks are manually pushed from the rack receiving deck 354 towards the first conveyor 330 so that they be conveyed towards the rear side 318.

In this specific embodiment, the second level 128 is above the first level 126, and the third conveyor 338 is on the first level 126. However, in other embodiments, the third conveyor 38 is on the second level 128. In some embodiments, both the first and second levels 24 and 26 have its corresponding conveyor for moving between the first and second lateral sides 20 and 22 of the frame 14

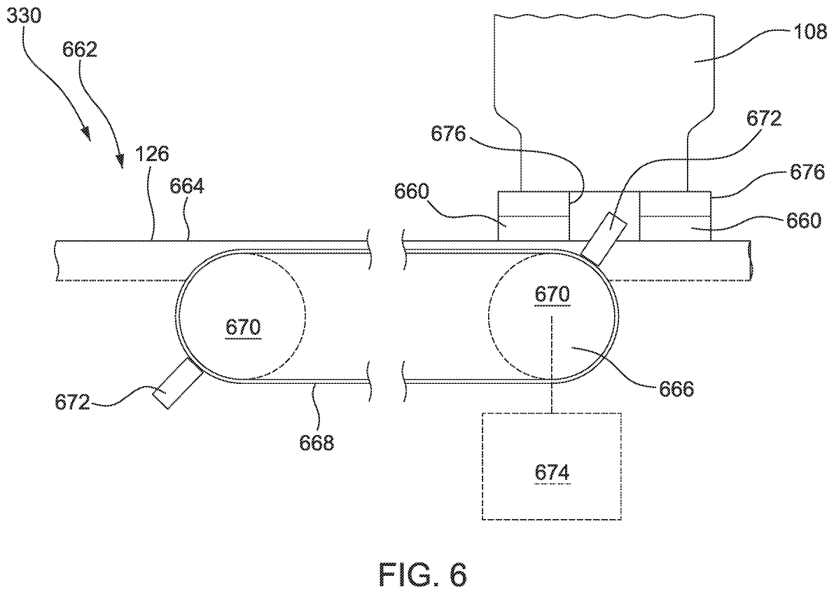

An example of the first conveyor 330 is described with reference to FIG. 6. As illustrated, any given rack 108 can be provided with low-friction feet 660 secured therebelow. In such cases, the first conveyor 330 is a belt conveyor 662 comprising a planar surface 664 extending along the first level 126, on which each rack 108 may slide, and a driving device 666 adapted to slide the rack 108 on the planar surface 664.

In this embodiment, the driving device 666 includes a belt 668 moving between two longitudinally spaced-apart pulleys 670. As depicted, the belt 668 has rack engaging elements 672 being spaced-apart from one another along a length of the belt 668. As the belt 668 is moved by the pulleys 670, which may be directly or indirectly driven by a motor 674, the rack engaging elements 672 engage corresponding engaging surfaces 676 of the racks 108 and move them along the length of the belt 668. Although this driving device 666 has been found to be satisfactory, any type of adequate driving device may be used. In alternate embodiments, the low-friction feet 660 can be replaced with rolling elements, rotatably secured under the racks 108, which may equivalently roll on the planar surface 664.

It is intended that the second and third conveyors 332 and 338 of the rack loader 104 can be configured similarly. However, in some embodiments, the first, second or third conveyor 330, 332, 338 can equivalently be provided in the form of a chain conveyor, a lineshaft roller conveyor, or any suitable type of conveying mechanism.

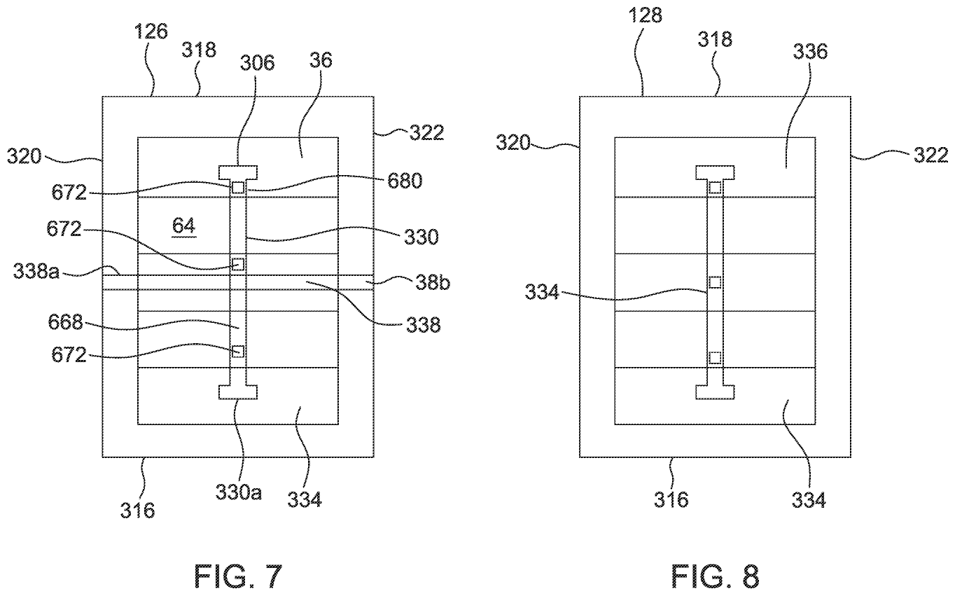

FIGS. 7 and 8 show schematic top views of examples of the first and second levels of the rack loader. As best seen in FIG. 7, the first conveyor 330 extends between a first end 330A adjacent the front side 316 and an opposite, second end 330B adjacent the rear side 318. The third conveyor 338 extends between the first end 338A adjacent the first lateral 320 and the second end 338B adjacent the second lateral side 322. As such, the first and third conveyors 330 and 338 are orthogonal to one another in this example. Although the third conveyor 330 is shown to be at a middle position of the first level 126 between the front and rear sides 316 and 318, the third conveyor 338 can be anywhere between the front and rear sides 316 and 318 of either one or both of the first and second levels 126 and 128.

More specifically, the first conveyor 330 has a planar surface 664 on which the racks can slide. As illustrated, the planar surface 664 has an elongated opening 680 extending between the first elevator 334 and the second elevator 336. The elongated opening 680 is sized and shaped to snugly receive rack engaging members 672 of a driving device 666 such as the one shown in FIG. 6, as they move along with the belt 668. In this way, a given rack on the first elevator 334, or anywhere on the first level 126 between the front and rear sides 316 and 318, can be moved longitudinally in a direction of movement of the rack engaging members 672 of the first conveyor 330. FIG. 7 shows that the second conveyor 332 has a construction similar to the first conveyor 330.

Referring back to FIG. 5, the first and second conveyors 330 and 332 can be adapted to continuously move the racks 108 on corresponding levels 126, 128. Alternatively, the first and second conveyors 330 and 332 can be adapted to stepwise move the racks 108. In this case, each rack 108 occupies a series of predetermined positions 678 during a corresponding predetermined period of time.

Moreover, in this example, the rack loader 104 has an identification reader 682 on the first level 126 which is adapted to read an identifier positioned on an exterior surface of the racks 108. In some embodiments, the identifier is positioned in an underside of the rack 108, and the identification reader 682 has a field of view encompassing the undersides of the racks 108 as they are moved over the identification reader 682. In some embodiments, the identifier is a radio frequency (RF) tag. In these embodiments, the identification reader 682 can be provided in the form of an RF tag reader connected to the controller 356 to automatically get the identifier from each rack of vessels.

In some embodiments, the controller 356 is adapted to receive the identifier from the identification reader 682 and then apply a set of parameters corresponding to the given rack 108 for controlling a priority of the given rack 108 among the other racks. For instance, a rack 108 identified with a higher priority may be loaded and unloaded into and from the microwave digestion system prior to another rack 108 having a lower priority.

FIG. 7 shows another example of a rack loader 900. As depicted, the rack loader 900 has a frame 914 having a front side 916, a rear side 918, and first and second lateral sides 920 and 922 which space apart the front and rear sides 916 and 918. The rack loader 900 has first and second levels 924 and 926 which are superposed inside the frame 914, with the second level 926 being above the first level 924 in this embodiment.

Similarly to the embodiment of FIG. 3, the rack loader 900 has a first conveyor 930 on the first level 924 moving between the front and rear sides 916 and 918 of the frame 914, a second conveyor 932 on the second level 926 moving between the front and rear sides 916 and 918 of the frame 914 and a third conveyor 938 on the first level 924 moving between the first and second lateral sides 920 and 922. However, in this example, the rack loader 900 has a single elevator 934 displaceable between the first and second levels 924 and 926. In this example, the elevator 934 is at the rear side 918 of the frame 914.

Moreover, in this specific example, the rack loader 900 has a fourth conveyor 984 on the second level 926 moving between the first and second lateral sides 920 and 922. In this way, racks 108 can be loaded and unloaded into and from a microwave digestion system 102 or an adjacent rack loader from each one of the two vertically-spaced apart levels 924 and 926.

As shown, the rack loader 900 has a rack input deck 954 coplanar with the first level 924 which extends on the front side 916 of the frame 914. Similarly, the rack loader 900 has a rack output deck 986 coplanar with the second level 928 which extends on the front side 916 of the frame 914 as well. Accordingly, as shown, the rack input and output decks 954 and 986 are above one another in this example. However, as can be understood, the rack output deck 986 is optional, as it can be omitted in some other embodiments.

In this way, a rack 108 can be received at the rack input deck 954, which can be moved across the first level 924 using the first conveyor 930. At some point during movement of the received rack 108 across the first level 924, the received rack 108 can be loaded and unloaded into and out of an adjacent microwave digestion system. Once the digested rack reaches the rear side 918 with the first conveyor 930, the elevator 934 can displace it to the second level 926, after which the second conveyor 932 can move the rack 108 across the second level 926 towards the rack output deck 986, where the rack 108 is readily accessible.

Although this embodiment shows the elevator 934 at the rear side 918, the elevator 934 can be spaced from the front and rear sides 916 and 918. For instance, the elevator 934 may be located at a middle portion of the first level 924, between the front and rear sides 916 and 918.

As shown, the rack loader 900 has a controller 956 which is communicatively coupled to the first, second, third and fourth conveyors 930, 932, 938 and 984 and to the elevator 934. As shown, the controller 956 has a processor 986 and a memory 988 having stored thereon instructions 990 which when executed by the processor 986 perform steps of controlling the first, second and third conveyors 930, 932 and 938 and the elevator 934. For instance, the controller 956 can be configured for loading and unloading each of the racks 108 of vessels independently from remaining ones of the racks 108 of vessels by controlling the first, second, and third conveyors 930, 932, 938 and 984 and the elevator 934 in a predetermined sequence. The controller 956 communicates with the controller 114 of the microwave digestion system 102 in a similar way as that described above with reference to FIG. 3.

For instance, in the illustrated example, an example of such a predetermined sequence can include a first longitudinal path 992 extending from the front side 916 to the rear side 918 in a first longitudinal direction, a vertical path 994 extending from the first level 924 to the second level 926 in a vertical direction, and a second longitudinal path 996 extending from the rear side 918 to the front side 916 in a second longitudinal direction opposite the first longitudinal direction.

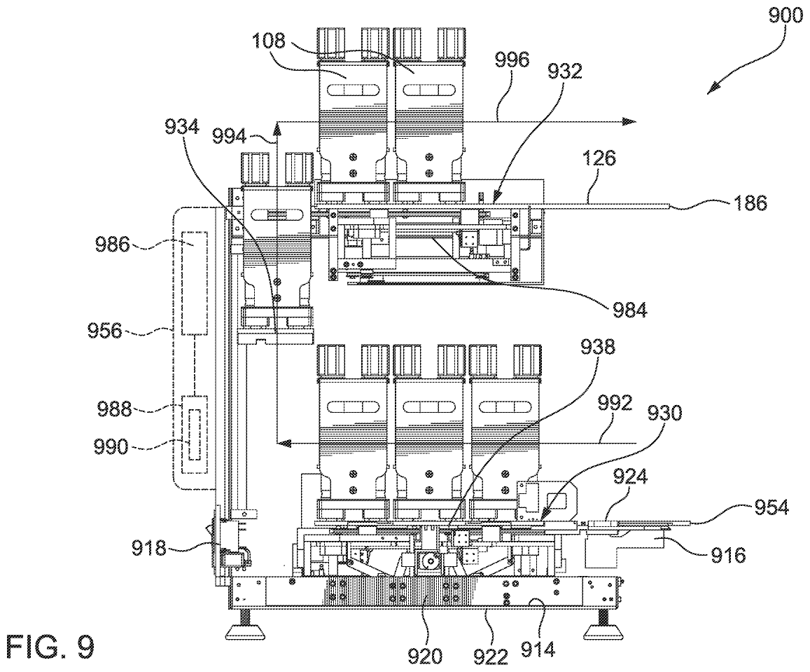

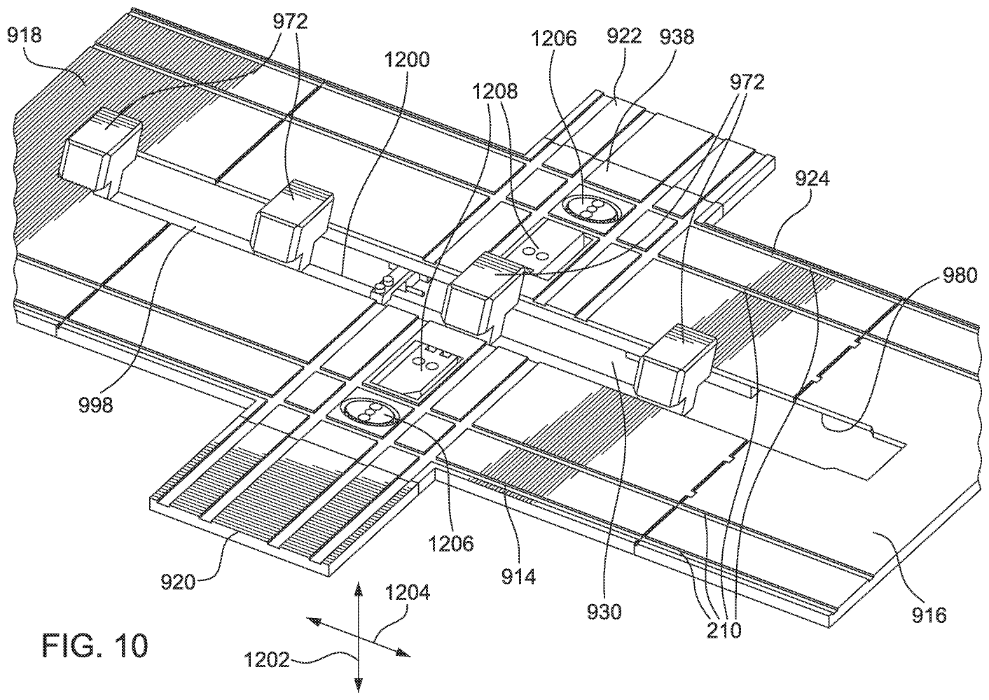

FIG. 10 is an oblique view of the first level 924 of the rack loader 900 of FIG. 9, showing examples of the first and third conveyors 930 and 938. As depicted, the first conveyor 930 has a driving device (not shown), and a rack engaging structure 998 which extends between the front and read sides 916 and 918 of the frame 914. More specifically, in this example, the rack engaging structure 998 has an elongated body 1200, and rack engaging elements 972 which extend away from the elongated body 1200 and which are spaced-apart from one another between the front and rear sides of the 916 and 918 of the frame 914.

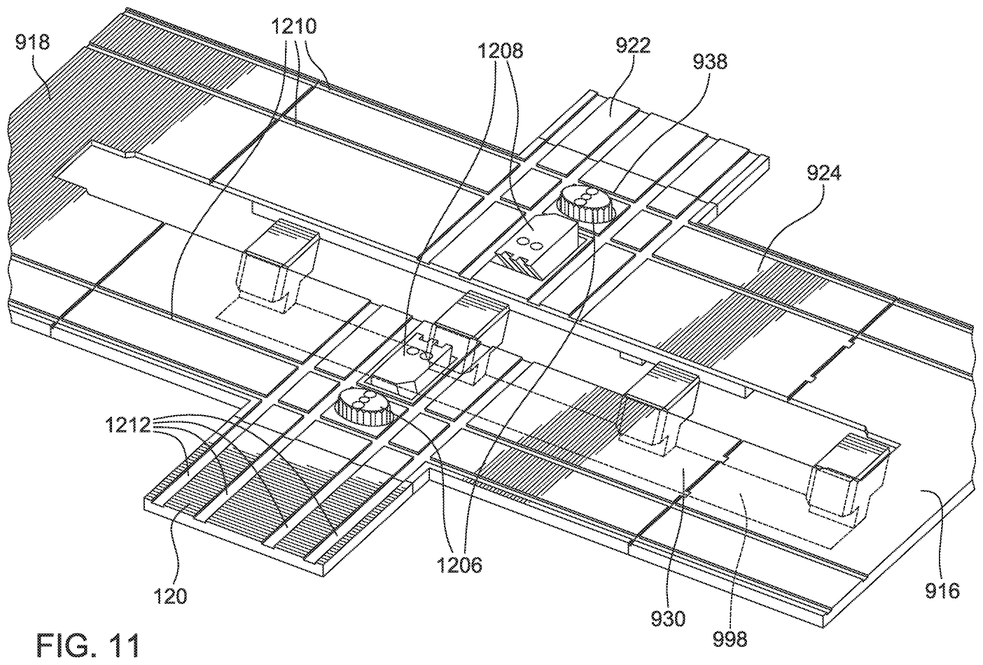

In this example, the driving device can move the rack engaging structure 998 in back and forth along a vertical orientation 1202. More specifically, the driving device can move the rack engaging structure 998 between a rack engaging position in which the rack engaging elements 972 protrude from the first level 924 through the elongated opening 980, such as shown in FIG. 10, and a rack disengaging position in which the rack engaging elements 972 are flush or recess from the first level 924, such as shown in FIG. 11.

The driving device can also move the rack engaging structure 998 in back and forth along a longitudinal orientation 1204. By doing so, the rack engaging structure 998 can be moved between the front and rear sides 916 and 918 of the frame 914, as desired.

Accordingly, when racks are received on the first level 924, the first conveyor 930 can move the rack engaging structure 998 in the rack engaging position, thereby engaging the rack engaging elements 972 of the rack engaging structure 998 with corresponding engaging surfaces of the racks (such as engaging surface 676 of the rack 108 in FIG. 5) and move the racks between the front and rear sides 916 and 918 of the frame 914.

When it is determined that the racks have been satisfactorily moved, the rack engaging structure 998 can be moved back into the rack disengaging position, which can then allow the rack engaging structure 998 to be moved longitudinally without engaging the racks. As the rack engaging elements 972 are made integral to the elongated body 1200, the racks can be moved simultaneously in either longitudinal direction between the front and rear sides 916 and 918 of the frame 914.

In this specific embodiment, the rack engaging structure 998 is moved in a series of identical movement cycles so as to move a given rack incrementally from a first position to a desired position along the first floor 924. For instance, an example of such a movement cycle can include, from the rack engaging structure 998 initially lying in the rack disengaging position, moving the rack engaging structure 998 in the rack engaging position, moving the rack engaging structure 998 along one longitudinal direction for a rack width, moving the rack engaging structure 998 back to the rack disengaging position, and moving the rack engaging structure 998 along an opposite longitudinal direction for the rack width back to the initial, rack disengaging position. Accordingly, if a given rack is to be moved from three incremental positions from the front side 916 to the rear side 918 of the frame 914, the rack engaging structure 998 can be moved in the movement cycle three successive times, for instance.

Still referring to FIG. 10, the third conveyor 938 has a driving device (not shown), and rack engaging gears 1206 which are laterally spaced-apart from one another between the first and second lateral sides 920 and 922 of the frame 914. Each rack engaging gear 1206 has a rotation axis which is oriented along the vertical orientation 1202.

The driving device can move the rack engaging gears 1206 between a rack disengaging position in which the rack engaging gears 1206 are flush or recess from the first level 924, such as shown in FIG. 10, and a rack engaging position in which the rack engaging gears 1206 protrude from the first level 924 through respective openings thereof, such as shown in FIG. 11.

The driving device can also rotate the rack engaging gears 1206 about their respective rotation axes when the rack engaging gears 1206, especially when the rack engaging gears 1206 are moved in the rack engaging position.

The third conveyor 938 is intended to be used with racks having a laterally extending series of teeth protruding from one of their respective rack engaging surface, such as the engaging surface 676 shown in FIG. 6. Accordingly, when such a rack is received on the first floor 924, aligned with the third conveyor 938, the third conveyor 938 can move the rack engaging gears 1206 in the rack engaging position, thereby gearingly engaging the rack engaging gears 1206 with the teeth of the rack. When such an engagement is achieved, the rack engaging gears 1206 can be rotated in a first rotational direction to move the rack towards the first lateral side 920 of the frame 914, or in an opposite, second rotational direction to move the rack towards the second lateral side 922 of the frame 914.

When it is determined that the racks have been satisfactorily moved, the rack engaging gears 1206 can be moved back into the rack disengaging position, which can then allow other racks to be move using the first conveyor 930.

The rack engaging structure 998 and the rack engaging gears 1206 can be moved simultaneously in opposite vertical direction by the same driving force if the rack engaging structure 998 and the rack engaging gears 1206 are mechanical connected to one another. In this way, the rack engaging gears 1206 may not obstruct rack movement along the lateral direction.

In this specific example, the third conveyor 938 also has rack engaging guides 1208 which extend laterally from one another. Still in this example, the rack engaging guides 1208 extend laterally between the first and second lateral sides 920 and 922 of the frame 914. However, in some other embodiments, the rack engaging guides 208 may be outside the first and second lateral sides 920 and 922, as long as they are aligned along the lateral orientation. The rack engaging guides 1208 are generally moved between the rack engaging position and the rack disengaging position simultaneously to the rack engaging gears 1206. Accordingly, the rack engaging guides 1208 can be used to guide the lateral movement of the racks as the rack engaging gear 1206 rotate.

As shown, the first floor 924 can have a first array of grooves 1210 recessed in the first floor 924 and extending between the front and rear sides 916 and 918 of the frame 914, a second array of grooves 1212 recessed in the first floor 924 and extending between the first and second lateral sides 920 and 922 of the frame 914. The grooves 1210 and 1212 can receive feet protruding from an undersurface of the racks to further guide the movement of the racks 108. In this example, the rack engaging guides 1208 together with the grooves 1210 ensure the racks move laterally by the rack engaging gears 1206.

The second conveyor 932 of the rack loader 900 of FIG. 9 can have a construction similar to that of the first conveyor 930 described above. It will be understood that the first and second conveyors 930 and 938 described with reference to the rack loader 900 of FIG. 9 can be alternately or additionally provided to the rack loader 104 of FIG. 3 in some other embodiments.

Although the illustrated embodiments show two levels being superposed, rack loaders can have more than two superposed levels in some other embodiments. For instance, in such embodiments, rack loaders can have first, second and third levels, or more, being superposed. In these embodiments, the spacing distances between two adjacent levels can be constant or different for each pair of adjacent levels.

As described above, the illustrated rack loaders have one or two elevators being displaceable between two adjacent levels. However, it is noted that, in other embodiments, the rack loader can have more than two elevators being displaceable between two adjacent levels. Elevators can even be displaceable between two non-adjacent levels also, depending on the embodiment.

The automated system 100 described herein may provide unattended sample digestion in accordance with multiple scenarios. For example, in a first scenario, the racks 108 are moved into and out of the microwave digestion system 102 by the rack loader 104, 900 in a sequential order, and the samples of each rack are digested. In a second scenario, the racks 108 are moved into and out of the microwave digestion system 102 by the rack loader 104, 900 in a user defined priority order, and the samples of each rack are digested. In a third scenario, selected racks are loaded and unloaded from the microwave digestion system 102 in accordance with a user defined priority order, and only samples in these selected racks are digested. In a fourth scenario, selected racks are loaded and unloaded from the microwave digestion system 102 in a sequential order, and only samples in these selected racks are digested. Unselected racks are omitted from digestion and remain on the rack loader 104, 900.

The following scenario is a specific and non-limiting example of sample digestion using the automated system 100 described herein. A rack 108 is programmed into the microwave digestion system 102 and placed into the autoloader 104, 900. The autoloader 104, 900 records the rack ID. An operator presses a button on the microwave digestion system 102 to start digestion. The autoloader 104, 900 moves the rack 108 into the microwave digestion system 102. The microwave digestion system 102 reads the rack ID and selects one or more digestion methods associated with the rack ID for sample digestion. The samples are digested according to the one or more digestion methods. Cameras 118 in the heating chamber record the sample digestions and temperature sensors 116 monitor the temperature during the digestion. When the digestion is completed, the rack 108 is returned to the autoloader 104, 900. The sequence starts all over if another rack 108 is in the digestion cycle.

In another non-limiting example of sample digestion using the automated system 100 described herein, artificial intelligence (AI) is incorporated into the process. For example, AI may be used to detect a vessel type (i.e. quartz, Teflon, etc) for the vessel recipients 110 in the racks and/or a sample type (i.e. soil, petroleum, food, etc), based on images captured by the cameras 118. The vessel type and/or sample type may also be determined from the rack ID. AI may also be used to determine a set point temperature of a sample based on feedback from the temperature sensors 116. AI may be used to detect events during sample digestion that would require a vent of the samples, such as loss of volume, no color change, bubbles forming, etc. If a vent is required for a sample, the controller 114 may adapt digestion parameters, such as reducing or turning off the microwave energy to the sample. AI may be used to determine the duration of the digestion, and to stop or extend the digestion based upon various criteria for the given sample.

Using the system described herein, the racks 108 provided on the autoloader 104, 900 for digestion by the microwave digestion system 102 may vary in sample type, vessel type, and/or digestion method. The system 100 may sort the racks 108 based on the rack IDs to determine an optimal sequence for digestion.

It will be understood that various digestion methods may be used, such as those defined by the Environment Protection Agency (EPA) and others.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A method for automated digestion of samples contained in multi-sample racks, the method comprising:
receiving the multi-sample racks on at least one of a first level and a second level of a first rack loader, the first level and the second level superposed and held within a frame;
managing rack positions on the first rack loader by displacing the multi-sample racks between the first level and the second level with at least one elevator;
conveying the multi-sample racks into and out of a heating chamber of a microwave digestion system from at least one of the first and second levels; and
controlling sample digestion inside the heating chamber through the application of microwaves by at least one microwave generator.

2. The method of claim 1, wherein conveying the multi-sample racks into and out of the heating chamber comprises:
determining a next rack for digestion in accordance with an order of digestion for the multi-sample racks;
displacing the next rack from a current position on the first rack loader to a loading position on the first rack loader; and
conveying the next rack from the loading position into the heating chamber.

3. The method of claim 1, wherein controlling sample digestion comprises:
identifying a rack for digestion;
retrieving a digestion method associated with the rack for digestion; and
applying the digestion method.

4. The method of claim 3, wherein applying the digestion method comprises applying different digestion methods to different samples in the rack through independent microwave application and temperature feedback of the samples in the multi-sample rack.

5. The method of claim 1, further comprising scanning identification tags of the multi-sample racks on the first rack loader, recording locations of the multi-sample racks on the first rack loader, and associating digestion methods to the multi-sample racks.

6. The method of claim 1, further comprising scanning identification tags of the multi-sample racks in the heating chamber, retrieving associated digestion methods, and controlling sample digestion in accordance with the digestion methods as retrieved.

7. The method of claim 1, wherein receiving the multi-sample racks on at least one of a first level and a second level of a first rack loader comprises receiving the multi-sample racks from at least one second rack loader aligned with the first rack loader to convey the multi-sample racks between the first rack loader and the at least one second rack loader.

8. The method of claim 1, further comprising cooling the samples post-digestion on the first rack loader.

9. The method of claim 1, wherein controlling sample digestion comprises monitoring the sample digestion via images acquired from inside the heating chamber.

10. The method of claim 9, wherein monitoring the sample digestion comprises detecting sample characteristics from the images and adjusting the sample digestion accordingly.

11. An automated system for digestion of samples contained in multi-sample racks, the system comprising:
a microwave digestion system having a heating chamber with an opening and at least one microwave generator communicatively coupled to the heating chamber for propagating therein microwaves to perform digestion of the samples;
a first rack loader coupled to the microwave digestion system and aligned with the opening of the heating chamber, the first rack loader having first and second levels superposed inside a first frame, a first set of conveyors for displacing the multi-sample racks between the first rack loader and the heating chamber, and a first elevator displaceable between the first and second levels; and
a controller coupled to the microwave device and the first rack loader and configured to manage displacement of the multi-sample racks on the first rack loader and between the first rack loader and the heating chamber, and control sample digestion through the application of microwaves by the at least one microwave device.

12. The automated system of claim 11, wherein the controller is configured for:
determining a next rack for digestion in accordance with an order of digestion for the multi-sample racks;
displacing the next rack from a current position on the first rack loader to a loading position on the first rack loader; and
conveying the next rack from the loading position into the heating chamber.

13. The automated system of claim 11, wherein the controller is configured for:
identifying a rack for digestion;
retrieving a digestion method associated with the rack for digestion; and
applying the digestion method.

14. The automated system of claim 11, wherein the rack loader comprises a reader to read rack identification tags of the multi-sample racks, and the controller is configured to record respective positions of the multi-sample racks in the first rack loader based on the rack identification tags.

15. The automated system of claim 11, wherein the heating chamber comprises a reader to read rack identification tags of the multi-sample racks, and the controller is configured to selectively applies digestion methods based on the rack identification tags.

16. The automated system of claim 11, further comprising at least one second rack loader aligned with the first rack loader, the second rack loader having third and fourth levels superposed inside a second frame, a second set of conveyors for displacing the multi-sample racks between the first rack loader and the at least one second rack loader, and a second elevator displaceable between the third and fourth levels.

17. The automated system of claim 11, wherein the microwave digestion system comprises at least one camera communicatively coupled to the heating chamber to acquire images of the samples during sample digestion.

18. The automated system of claim 11, wherein the microwave digestion system comprises independent microwave applicators for each sample of the multi-sample racks.

19. The automated system of claim 11, wherein the microwave digestion system comprises independent temperature feedback for each sample of the multi-sample racks.

20. A rack loader for loading and unloading a plurality of multi-sample racks into and out of a microwave digestion system, the rack loader comprising:
a frame having a front side, a rear side, and first and second lateral sides spacing apart the front and rear sides;
first and second levels superposed inside the frame;
a set of conveyors for displacing the multi-sample racks on the rack loader and between the rack loader and a heating chamber of the microwave digestion system; and
an elevator displaceable between the first and second levels.

21. The rack loader of claim 20, wherein the set of conveyors comprises:
a first conveyor on the first level moving between the front and rear sides of the frame;
a second conveyor on the second level moving between the front and rear sides of the frame; and
a third conveyor on at least one of the first and second levels moving between the first and second lateral sides.

22. The rack loader of claim 21, wherein the set of conveyors comprises a fourth conveyor on the other one of the first and second levels moving between the first and second lateral sides.

23. The rack loader of claim 20, wherein the elevator is a first elevator, the rack loader further comprising a second elevator spaced-apart from the first elevator and displaceable between the first and second levels.

24. The rack loader of claim 20, further comprising a rack receiving deck coplanar with the first level and disposed on one of the front and rear sides of the frame.

25. The rack loader of claim 20, wherein the frame is a housing enclosing the first and second levels, the set of conveyors and the elevator, the housing having at least one opening leading to at least one of the first and second levels.

26. The rack loader of claim 20, further comprising a scanner for reading rack identification tags on the multi-sample racks.

27. The rack loader of claim 20, wherein the frame comprises alignment features for aligning with the heating chamber of the microwave digestion system.

28. The rack loader of claim 20, wherein the rack loader is electronically connectable to the microwave digestion system.

29. The rack loader of claim 20, wherein control of the set of conveyors and the elevator is effected by the microwave digestion system.
